(19) United States
(12) Patent Application Publication
(10) Pub. No.: US 2022/0308659 A1
(43) Pub. Date: Sep. 29, 2022

(54) METHOD FOR INTERACTING WITH VIRTUAL ENVIRONMENT, ELECTRONIC DEVICE, AND COMPUTER READABLE STORAGE MEDIUM

(71) Applicant: HTC Corporation, Taoyuan City (TW)

(72) Inventor: Cheng-Ting Yen, Taoyuan City (TW)

(73) Assignee: HTC Corporation, Taoyuan City (TW)

(21) Appl. No.: 17/209,261

(22) Filed: Mar. 23, 2021

(51) Int. Cl. G06F 3/01; G06F 3/0346

(52) U.S. Cl. CPC G06F 3/013; G06F 3/0346; G06F 3/012; G06F 2203/0381

(57) ABSTRACT

The disclosure provides a method for interacting with a virtual environment, an electronic device, and a computer readable storage medium. The method includes: displaying a virtual environment, wherein the virtual environment includes a virtual object and a controller representative object having a first visual type; defining a detection space, wherein the virtual object locates in the detection space; in response to determining that the controller representative object locates in the detection space or a gaze direction of a user of the electronic device points to the detection space, transforming the controller representative object to a second visual type, wherein the controller representative object with the second visual type is used to interact with the virtual object; and adjusting the virtual environment in response to determining that the controller representative object with the second visual type reaches the virtual object.

### BACKGROUND

### 1. Field of the Invention

The disclosure generally relates to a virtual reality (VR) technology, in particular, to a method for interacting with a virtual environment, an electronic device, and a computer readable storage medium.

### 2. Description of Related Art

In virtual environments such as VR environments, the user may need to perform typing operation to input characters from time to time. However, the conventional way for the user to type in the virtual environments may be inconvenient for the user to use.

For example, when the user wants to input some characters on the virtual keyboard provided in the virtual environments, the user may need to put the gaze thereof on those characters on the virtual keyboard, which may make the user feel tired and inconvenient.

### SUMMARY OF THE INVENTION

Accordingly, the present disclosure is directed to a method for interacting with a virtual environment, an electronic device, and a computer readable storage medium, which may be used to solve the above technical problems.

The embodiments of the disclosure provide a method for interacting with a virtual environment, adapted to an electronic device. The method includes: displaying a virtual environment, wherein the virtual environment includes a virtual object and a controller representative object having a first visual type; defining a detection space, wherein the virtual object locates in the detection space; in response to determining that the controller representative object locates in the detection space or a gaze direction of a user of the electronic device points to the detection space, transforming the controller representative object to a second visual type, wherein the controller representative object with the second visual type is used to interact with the virtual object; and adjusting the virtual environment in response to determining that the controller representative object with the second visual type reaches the virtual object.

The embodiments of the disclosure provide an electronic device including a storage circuit and a processor. The storage circuit stores a program code. The processor is coupled to the storage circuit and accesses the program code to perform: displaying a virtual environment, wherein the virtual environment includes a virtual object and a controller representative object having a first visual type; defining a detection space, wherein the virtual object locates in the detection space; in response to determining that the controller representative object locates in the detection space or a gaze direction of a user of the electronic device points to the detection space, transforming the controller representative object to a second visual type, wherein the controller representative object with the second visual type is used to interact with the virtual object; and adjusting the virtual environment in response to determining that the controller representative object with the second visual type reaches the virtual object.

The embodiments of the disclosure provide a computer readable storage medium, recording an executable computer program to be loaded by an electronic device to execute steps of: displaying a virtual environment, wherein the virtual environment includes a virtual object and a controller representative object having a first visual type; defining a detection space, wherein the virtual object locates in the detection space; in response to determining that the controller representative object locates in the detection space or a gaze direction of a user of the electronic device points to the detection space, transforming the controller representative object to a second visual type, wherein the controller representative object with the second visual type is used to interact with the virtual object; and adjusting the virtual environment in response to determining that the controller representative object with the second visual type reaches the virtual object.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a functional diagram of an electronic device according to an embodiment of the disclosure.

FIG. 2 shows a flow chart of the method for interacting with a virtual environment according to an embodiment of the disclosure.

FIG. 3A and FIG. 3B show application scenario according to embodiments of the disclosure.

FIG. 4A shows a schematic diagram of interacting with the virtual object by using the controller representative object with the second visual type according to an embodiment of the disclosure.

FIG. 4B shows another schematic diagram of interacting with the virtual object by using the controller representative object with the second visual type according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

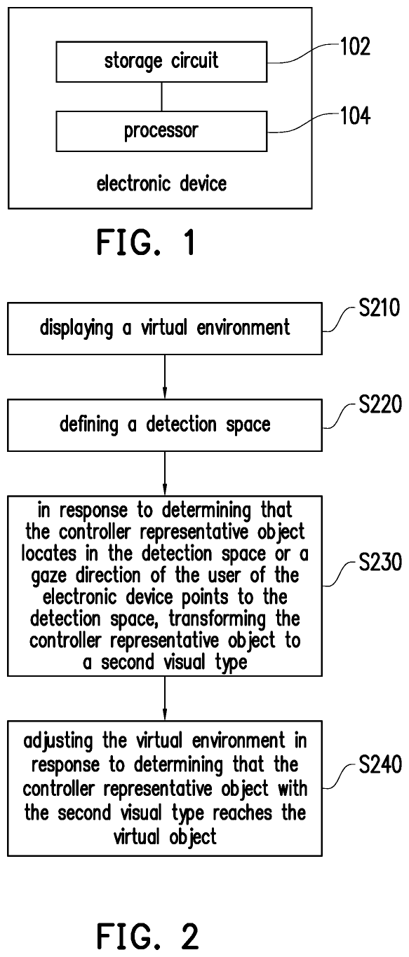

See FIG. 1, which shows a functional diagram of an electronic device according to an embodiment of the disclosure. In various embodiments of the disclosure, the electronic device 100 may be a head-mounted device (HMD) or a host device (e.g., a computer) of a VR system, but the disclosure is not limited thereto. In some embodiments, the VR system may also include other elements such as a position tracking device and at least one controller that can be held by the user of the electronic device 100, but the disclosure is not limited thereto.

In FIG. 1, the electronic device 100 may include a storage circuit 102 and a processor 104. The storage circuit 102 is one or a combination of a stationary or mobile random access memory (RAM), read-only memory (ROM), flash memory, hard disk, or any other similar device, and which records a plurality of modules that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In the embodiments of the disclosure, the processor 104 may access the modules and/or program codes stored in the storage circuit 102 to implement the method for interacting with a virtual environment provided in the disclosure, which would be further discussed in the following.

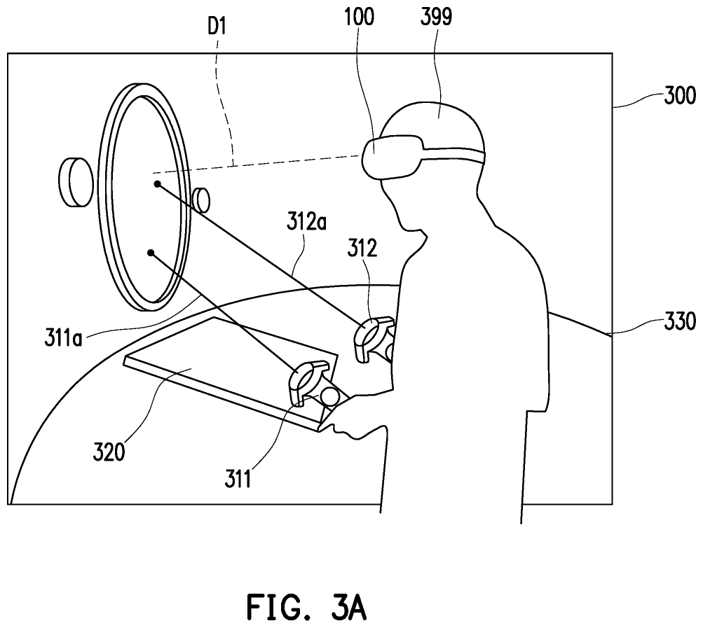

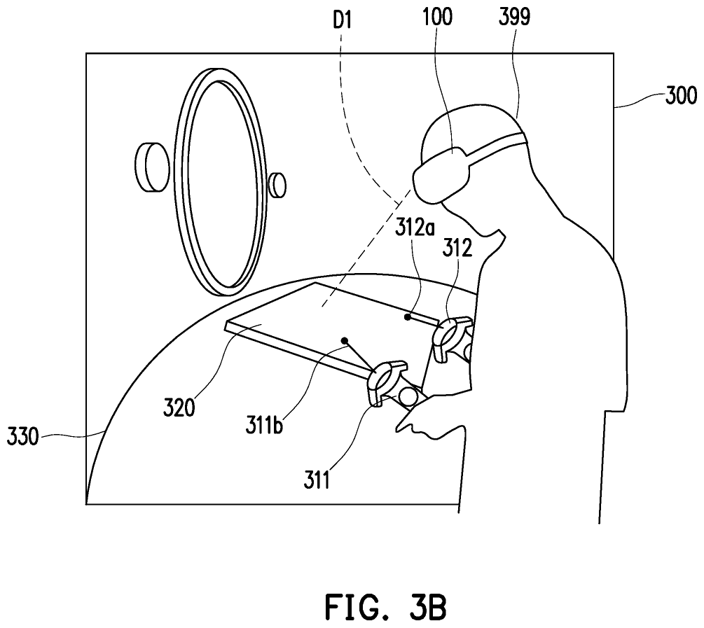

See FIG. 2, which shows a flow chart of the method for interacting with a virtual environment according to an embodiment of the disclosure. The method of this embodiment may be executed by the electronic device 100 in FIG. 1, and the details of each step in FIG. 2 will be described below with the components shown in FIG. 1. In addition, for better understanding the concept of the disclosure, FIG. 3A and FIG. 3B, which show application scenario according to embodiments of the disclosure, would be used as examples, but the disclosure is not limited thereto.

Firstly, in step S210, the processor 104 may display a virtual environment 300, wherein the virtual environment 300 may be a virtual world provided by the VR system and shown to the user 399 of the electronic device 100. In FIG. 3A, the virtual environment 300 may include controller representative objects 311, 312 and a virtual object 320.

In the embodiments of the disclosure, the controller representative objects 311, 312 may move in the virtual environment 300 in response to movements of the controllers of the VR system. For example, the controller representative object 311 may correspond to the left controller held by the left hand of the user 399, and the controller representative object 312 may correspond to the right controller held by the right hand of the user 399. In this case, when the user 399 moves the left controller, the controller representative object 311 would be correspondingly moved in the virtual environment 310. Similarly, when the user 399 moves the right controller, the controller representative object 312 would be correspondingly moved in the virtual environment 310, but the disclosure is not limited thereto.

In various embodiments, the virtual object 320 may be any VR object that is interactable with the controller representative objects 311 and 312 (e.g., a virtual keyboard for the user 399 to perform typing operation). More specifically, in the embodiments of the disclosure, each of the controller representative objects 311, 312 may appear as in a first visual type or a second visual type, and only the controller representative objects 311, 312 with the second visual type may be used to interact with the virtual object 320. From another perspective, the controller representative objects 311, 312 with the first visual type are not allowed to interact with the virtual object 320.

In the embodiments of the disclosure, the first visual type of the controller representative objects 311 and 312 may be assumed to have the appearances shown in FIG. 3A. That is, the first visual type may shape like a real controller of the VR system while having a pointing ray (e.g., the pointing rays 311a, 312a) emitted therefrom, but the disclosure is not limited thereto.

In the embodiments of the disclosure, the controller representative object 311 would be used as an example for following discussions, and people with ordinary skills in the art should be able to understand how the method of the disclosure works with respect to the controller representative object 312, but the disclosure is not limited thereto.

In FIG. 3A, after displaying the virtual environment 300 having the controller representative object 311 and the virtual object 320, in step S220, the processor 104 may define a detection space 330. In the embodiments of the disclosure, the detection space 330 may be a virtual space where the virtual object 320 locates in, but the disclosure is not limited thereto.

In one embodiment, the user 399 may need to look down by certain degrees (e.g., 30 degrees) before interacting with the virtual object 320. That is, if the user 399 intends to interact with the virtual object 320, the electronic device 100 worn by the user 399 may be correspondingly rolled by certain degrees (e.g., −30 degrees). Therefore, the designer may define a predetermined rolling angle range of the electronic device 100 in advance, wherein the predetermined rolling angle range may be understood as how low the user 399 looks down should be regarded as intending to interact with the virtual object 320.

For example, the predetermined rolling angle range may range between −30 degrees and −90 degrees. That is, if the electronic device 100 is detected to be rolled by a specific degree (i.e., the user 399 looks down by the specific degree) in the predetermined rolling angle range, it represents that the user 399 may intend to interact with the virtual object 320.

Therefore, in the procedure where the processor 104 defines the detection space 330, the processor 104 may firstly obtain the predetermined rolling angle range of the electronic device 100 and define the detection space 330 according to the predetermined rolling angle range.

For example, if the predetermined rolling angle range has a first boundary angle (e.g., −30 degrees) and a second boundary angle (e.g., −90 degrees), the processor 104 may obtain a first visual plane when the electronic device 100 is rolled by the first boundary angle and obtain a second visual plane when the electronic device 100 is rolled by the second boundary angle. Next, the processor 104 may define the space between the first visual plane and the second visual plane as the detection space 330, but the disclosure is not limited thereto.

In another embodiment, in the procedure where the processor 104 defines the detection space 330, the processor 104 may obtain a specific space occupied by the virtual object 320 in the virtual environment 300, expand the specific space based on a predetermined size ratio, and define the expanded space as the detection space 330. For example, assuming that the predetermined size ratio is N (e.g., 1.5), the processor 104 may expand the specific space to a size with N (e.g., 1.5) times volume of the original size of the specific space, and the expanded specific space may be defined as the detection space 330, but the disclosure is not limited thereto.

In some embodiments, the processor 104 may determine whether the controller representative object 311 locates in the detection space 330. If yes, it represents that the user 399 may intend to interact with the virtual object 320.

In addition, the processor 104 may also determine whether a gaze direction D1 of the user 399 of the electronic device 100 points to the detection space 330. If the gaze direction D1 of the user 399 of the electronic device 100 is determined to point to the detection space 330, it may also represent that the user 399 may intend to interact with the virtual object 320. In some embodiments, the gaze direction D1 may be obtained by performing eye tracking to the user 399 of the electronic device 100. In other embodiments, the gaze direction D1 may be characterized as a normal direction of a front camera (not shown) of the electronic device 100, but the disclosure is not limited thereto.

Therefore, in step S230, in response to determining that the controller representative object 311 locates in the detection space 330 or the gaze direction D1 of the user 399 of the electronic device 100 points to the detection space 330, the processor 104 may transform the controller representative object 311 to the second visual type.

In the embodiments of the disclosure, the second visual type of the controller representative objects 311 and 312 may be assumed to have the appearances shown in FIG. 3B. That is, the second visual type may shape like a real controller of the VR system while having a specific line segment (e.g., the specific line segments 311b and 312b) extended therefrom by a predetermined length, but the disclosure is not limited thereto.

In other embodiments, the second visual type of the controller representative objects 311 and 312 may be designed to have other appearances, such as a stick-shaped object or other geometric object preferred by the designer, but the disclosure is not limited thereto.

Next, in step S240, the processor 104 may adjust the virtual environment 300 in response to determining that the controller representative object 311 with the second visual type reaches the virtual object 320. For example, assuming that the virtual object 320 is a keyboard including a plurality of keys, the user 399 may use the controller representative object 311 with the second visual type to hit the desired keys on the keyboard for performing typing operations. In this case, in response to determining that the controller representative object 311 reaches a specific key of the keys on the keyboard, the processor 104 may perform a typing operation according to the specific key.

In some embodiments, the processor 104 may determine whether the specific line segment 311b of the controller representative object 311 reaches a specific key of the keys on the keyboard. If yes, the processor 104 may perform a typing operation according to the specific key, but the disclosure is not limited thereto.

In this case, the method of the disclosure may allow the user 399 to use the controller representative object 311 with the second visual type to hit the virtual object 320 like beating a drum to perform typing operation, which provides a novel way for the user 399 to interact with the virtual environment 300.

In some embodiments, if the processor 104 determines that the gaze direction D1 fails to point to the detection space 330, it may represent that the user 399 does not intend to interact with the virtual object 320. Therefore, in response to determining that the gaze direction D1 fails to point to the detection space 330, the processor 104 may transform the controller representative object 311 to the first visual type shown in FIG. 3A.

Similarly, if the processor 104 determines that the controller representative object 311 leaves the detection space 330, it may also represent that the user 399 does not intend to interact with the virtual object 320. Therefore, in response to determining that the controller representative object 311 leaves the detection space 330, the processor 104 may transform the controller representative object 311 to the first visual type shown in FIG. 3A, but the disclosure is not limited thereto.

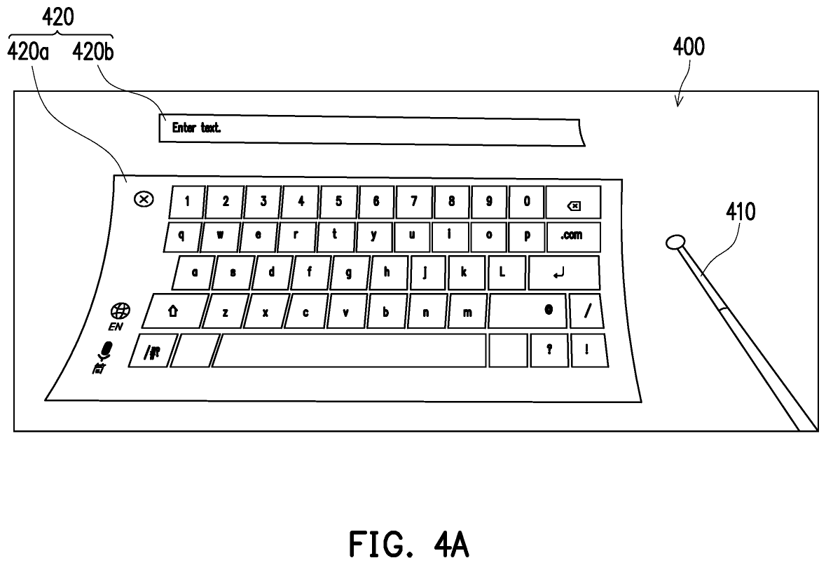

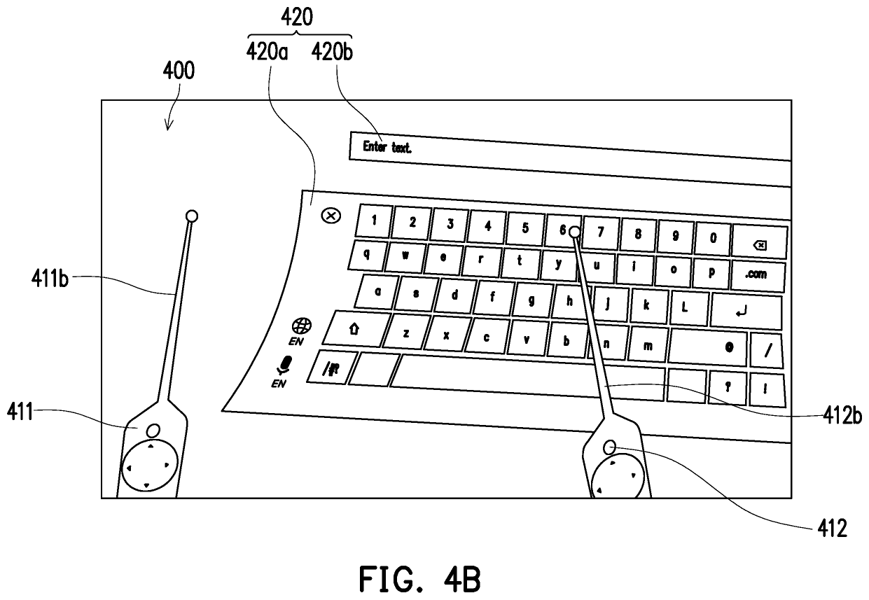

See FIG. 4A, which shows a schematic diagram of interacting with the virtual object by using the controller representative object with the second visual type according to an embodiment of the disclosure. In FIG. 4A, the processor 104 may display the virtual environment 400 to the user of the electronic device 100, wherein the virtual environment 400 may include the controller representative object 410 and the virtual object 420. In the present embodiment, the virtual object 420 may include a keyboard 420a and an input box 420b for the user to perform typing operation.

In the embodiment of FIG. 4A, the controller representative object 410 may have been transformed to the second visual type. Specifically, the second visual type in the embodiment may have an appearance shaped like a drum stick. Therefore, the user may be allowed to use the controller representative object 410 with the second visual type to hit the keys on the keyboard 420a, and the characters, numbers, symbols, etc. corresponding to the keys being hit would be correspondingly displayed in the input box 420b.

See FIG. 4B, which shows another schematic diagram of interacting with the virtual object by using the controller representative object with the second visual type according to an embodiment of the disclosure. In FIG. 4B, the processor 104 may display the virtual environment 400 to the user of the electronic device 100, wherein the virtual environment 400 may include the controller representative objects 411, 412 and the virtual object 420. In the present embodiment, the virtual object 420 may include a keyboard 420a and an input box 420b for the user to perform typing operation.

In the embodiment of FIG. 4B, the controller representative objects 411 and 412 may have been transformed to the second visual type. Specifically, the second visual type in the embodiment may have an appearance shaped like a real controller but with a specific line segment (e.g., the specific line segments 411b and 412b) extends therefrom. Therefore, the user may be allowed to use the controller representative objects 411 and 412 with the second visual type to hit the keys on the keyboard 420a, and the keys being hit would be correspondingly displayed in the input box 420b.

The disclosure further provides a computer readable storage medium for executing the method for interacting with a virtual environment. The computer readable storage medium is composed of a plurality of program instructions (for example, a setting program instruction and a deployment program instruction) embodied therein. These program instructions can be loaded into the electronic device 100 and executed by the same to execute the method for interacting with a virtual environment and the functions of the electronic device 100 described above.

In summary, the embodiments of the disclosure may determine the controller representative object to be the first visual type or the second visual type based on whether the controller representative object locates in the detection space and/or the gaze direction of the user points to the detection space where the virtual object locates. In response to determining that the controller representative object locates in the detection space and/or the gaze direction of the user points to the detection space, the controller representative object may be transformed (from the first visual type) to the second visual type, such that the user may be allowed to interact with the virtual object by using the controller representative object with the second visual type.

In addition, in response to determining that the controller representative object leaves the detection space and/or the gaze direction of the user fails to point to the detection space, the controller representative object may be transformed (from the second visual type) to the first visual type, such that the user may use the controller representative object with the first visual type to interact with the virtual environment in other ways. Accordingly, the embodiments of the disclosure provide a novel way for the user to interact with the virtual environment by using the controller representative object with different visual types.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for interacting with a virtual environment, adapted to an electronic device, comprising:
displaying a virtual environment, wherein the virtual environment comprises a virtual object and a controller representative object having a first visual type, wherein the controller representative object with the first visual type is not allowed to interact with the virtual object;
defining a detection space, wherein the virtual object locates in the detection space, wherein the detection space is a virtual space within the virtual environment, and the detection space is smaller than the virtual environment;
in response to determining that a gaze direction of a user of the electronic device points to the detection space, transforming the controller representative object to a second visual type, wherein the controller representative object with the second visual type is used to interact with the virtual object;
adjusting the virtual environment in response to determining that the controller representative object with the second visual type reaches the virtual object; and
in response to determining that the gaze direction fails to point to the detection space, transforming the controller representative object to the first visual type.

2. The method according to claim 1, wherein the step of defining the detection space comprises:
obtaining a predetermined rolling angle range of the electronic device; and
defining the detection space according to the predetermined rolling angle range.

3. (canceled)

4. The method according to claim 1, wherein the step of defining the detection space comprises:
obtaining a specific space occupied by the virtual object in the virtual environment;
expanding the specific space based on a predetermined size ratio;
defining the expanded space as the detection space.

5. (canceled)

6. The method according to claim 1, wherein the controller representative object moves in the virtual environment in response to a movement of a controller of a virtual reality system, and the electronic device is a head-mounted display of the virtual reality system.

7. The method according to claim 1, wherein the controller representative object with the first visual type has a pointing ray emitted from the controller representative object.

8. The method according to claim 1, wherein the controller representative object with the second visual type has a specific line segment extended from the controller representative object by a predetermined length.

9. The method according to claim 1, wherein after the step of transforming the controller representative object to the second visual type, the method further comprises:
in response to determining that the controller representative object leaves the detection space, transforming the controller representative object to the first visual type.

10. The method according to claim 1, wherein the virtual object is a keyboard comprising a plurality of keys, and the step of adjusting the virtual environment in response to determining that the controller representative object reaches the virtual object comprises:
in response to determining that the controller representative object reaches a specific key of the keys on the keyboard, performing a typing operation according to the specific key.

11. An electronic device, comprising:
a non-transitory storage circuit, storing a program code;
a processor, coupled to the storage circuit, accessing the program code to perform:
displaying a virtual environment, wherein the virtual environment comprises a virtual object and a controller representative object having a first visual type, wherein the controller representative object with the first visual type is not allowed to interact with the virtual object;
defining a detection space, wherein the virtual object locates in the detection space, wherein the detection space is a virtual space within the virtual environment, and the detection space is smaller than the virtual environment;
in response to determining that a user of the electronic device points to the detection space, transforming the controller representative object to a second visual type, wherein the controller representative object with the second visual type is used to interact with the virtual object;
adjusting the virtual environment in response to determining that the controller representative object with the second visual type reaches the virtual object; and
in response to determining that the gaze direction fails to point to the detection space, transforming the controller representative object to the first visual type.

12. The electronic device according to claim 11, wherein the processor performs:
obtaining a predetermined rolling angle range of the electronic device; and
defining the detection space according to the predetermined rolling angle range.

13. (canceled)

14. The electronic device according to claim 11, wherein the processor performs:
obtaining a specific space occupied by the virtual object in the virtual environment;
expanding the specific space based on a predetermined size ratio;
defining the expanded space as the detection space.

15. (canceled)

16. The electronic device according to claim 11, wherein the controller representative object moves in the virtual environment in response to a movement of a controller of a virtual reality system, and the electronic device is a head-mounted display of the virtual reality system.

17. The electronic device according to claim 11, wherein the controller representative object with the first visual type has a pointing ray emitted from the controller representative object, and the controller representative object with the second visual type has a specific line segment extended from the controller representative object by a predetermined length.

18. The electronic device according to claim 11, wherein after transforming the controller representative object to the second visual type, the processor further performs:
in response to determining that the controller representative object leaves the detection space, transforming the controller representative object to the first visual type.

19. The electronic device according to claim 11, wherein the virtual object is a keyboard comprising a plurality of keys, and processor performs:
in response to determining that the controller representative object reaches a specific key of the keys on the keyboard, performing a typing operation according to the specific key.

20. A non-transitory computer readable storage medium, recording an executable computer program to be loaded by an electronic device to execute steps of:
displaying a virtual environment, wherein the virtual environment comprises a virtual object and a controller representative object having a first visual type, wherein the controller representative object with the first visual type is not allowed to interact with the virtual object;
defining a detection space, wherein the virtual object locates in the detection space, wherein the detection space is a virtual space within the virtual environment, and the detection space is smaller than the virtual environment;
in response to determining that a gaze direction of a user of the electronic device points to the detection space, transforming the controller representative object to a second visual type, wherein the controller representative object with the second visual type is used to interact with the virtual object;
adjusting the virtual environment in response to determining that the controller representative object with the second visual type reaches the virtual object; and
in response to determining that the gaze direction fails to point to the detection space, transforming the controller representative object to the first visual type.
